(19) United States
(12) Patent Application Publication
(10) Pub. No.: US 2006/0010002 A1
(43) Pub. Date: Jan. 12, 2006

(54) Method for storage and administration of data and arrangement for implementation of the method

(76) Inventors: Christoph Kunde, Berlin (DE); Ralf Muller, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/175,062

(22) Filed: Jul. 5, 2005

(30) Foreign Application Priority Data
Jul. 7, 2004 (DE) 10 2004 033 598.2

(51) Int. Cl. G06Q 99/00

(52) U.S. Cl. 705/1

(57) ABSTRACT

In a method for storage and administration of data, with storage division into a first storage region and into a second storage region, storage of result data in the first storage region occurs until exceeding a threshold, followed by copying and compression of first data from at least the lower address range of the first storage region until the data compression is concluded followed by storage of the compressed first data in a second storage region. The first data at least in the lower address range of the first storage region are erased. Second data from the upper address range of the first storage region are shifted to the lower address range of the first storage region. An arrangement for implementation of the method has a non-volatile storage, a microprocessor and a program memory that are operationally connected with one another and appropriately program the microprocessor.

### BACKGROUND OF THE INVENTION

1. Field of the Invention

The invention concerns a method for storage and administration of data suitable for franking machines or franking systems and for other mail processing apparatuses and their peripheral devices.

2. Description of the Prior Art

The franking machine JetMail®, commercially available from Francotyp-Postalia Beteiligungs AG, is equipped with a base and a removable meter that contains a controller for controlling the printing and for controlling peripheral components of the franking machine. The base contains a mail piece transport device and an inkjet printer for printing the postage value imprint on the mail piece. The meter is operationally connected with a static scale integrated into the base housing and is, among other things, also used for postage calculation. The meter contains a security module that is equipped with a cryptographic unit in addition to a billing unit. The latter serves for securing an internally stored credit and the mail fee data to be printed.

The security module is used in different manners by service providers, but at a minimum is used when security-relevant data must be exchanged over an insecure data transfer path in a communication with a remote data center. The meter housing or the housing of a franking machine offers a first line of protection against manipulations with the intent of counterfeiting. Encapsulation of the security module by means of a special housing offers additional mechanical protection. Such an encapsulated security module satisfies the current postal requirements and is also designated as a postal security device (PSD). In some countries, credit downloading requires security measures that only a PSD can provide. The aforementioned known franking machines is connected with a tele-postage center in a known manner for telephonic credit downloading and can be expanded into a franking system with further devices.

Furthermore, it is known to exchange security data between a franking system and a data center remote therefrom via modem, the franking system containing a postal security device (PSD). Such franking machines or franking systems are commercially available from Francotyp-Postalia Beteiligungs AG under the names Mymail® and Ultimail®.

Another service of a postal carrier is a statistical tracking of franked mail according to statistics classes. Detection of pre-compressed data according to statistic classes in the franking machine is known from European Application 892368 that leads to an intentional storage space reduction due to the pre-compression. However, the storage is not continuous and cannot be queried at arbitrary points in time, but rather only periodically or according to stipulated time spans, in particular time spans that are pre-selected according to the desires of the respective postal carrier. Procedures wherein statistics classes (class of mail) are stored until the remote data center accesses them in order to determine a user profile are also known from European Applications 992947 and 101383. Data compression ensues in a manner independent of the desires of the respective postal carrier, but reduces the higher information content of the uncompressed data.

An arrangement and a method for improvement of data security by means of circular buffers is known in connection with further security measures from European Patent 854 425. Error data are securely stored in a circular buffer in a franking machine, even in the case of a voltage drop (power loss). This known approach, however, has the disadvantage of requiring substantial storage space for little data, and data are lost, such that not all of the data can be constantly interrogated from the storage. No indication of a further storage region with compressed data exists.

### SUMMARY OF THE INVENTION

An object of the present invention is to provide a method for storage, and administration of data and an arrangement for implementation of the method, which ensure storage, external from the postal security device in a franking machine, of the point in time and the type of the occurrence of an event in order to be able display or further process the corresponding data. Information about an event should be able to be displayed, in particular when the event has occurred. This should be accomplished while making optimal use of the available storage space, so that the arrangement for storage and administration of data operates without additional storage space.

The invention is based on the recognition that each compression of data also entails an information loss. Therefore, a variable part of the storage region remains occupied by uncompressed data in order to be able to use the higher information content of the data, while data compression algorithms are applied that enable filling of the memory without overflow.

For the logging of data, for example error and/or event data, data are written into a first non-volatile memory upon the occurrence of an event that is to be tracked. The data can include an event identification, time information and arbitrary further information. If, in the case of storage of uncompressed data, the sub-region provided for this purpose in the first non-volatile storage region is exceeded, a compression of a part of the data ensues and of the compressed data are stored in a separate, second non-volatile storage region, for example in a statistic class that essentially contains only information as to how often an event occurred. The memory formed by the first and second non-volatile storage regions is also designated as a log memory, but can be formed by two separate memory units. The first non-volatile storage region is also designated as uncompressed storage NCM (non-compressed memory) and may be composed, for example, of four sub-regions. An overflow of a threshold and thus a full occupancy of the sub-regions can be established by a testing (checking) of the addresses. The second non-volatile storage region is also designated as a compressed storage CM (compressed memory).

The data handled by the method for storage and administration of data originate from a storage distribution and proceed into a first storage region and into a second storage region according to the steps:
(i) storage of data associated with a type of event upon the successive occurrences of the event in the first storage region until overflow of a threshold at the transition between sub-regions thereof,
(ii) copying and compression of first data from at least the sub-regions in the lower address range of the first storage region until the data compression is concluded,
(iii) storage of the compressed first data in the second storage region,
(iv) deletion of the first data at least from the sub-regions in the lower address range of the first storage region and
(v) shifting of second data from the sub-regions in the upper address range of the first storage region to a sub-region in the lower address range of the first storage region, whereby the shifted second data represent last-stored events.

The method combines the advantage of a higher information content in the remaining uncompressed data with a high storage capability for compressed data. The data compression ensues according to a data compression algorithm in which at least parts of uncompressed data of the log memory are read and compressed. The newly-compressed data and the already-compressed and stored data are merged upon compression and stored as compressed data in the second non-volatile storage region or in a separate storage (compressed memory). The data of the log memory are shifted in the event of compression such that the last-registered data are shifted into a sub-region in a lower address range of the first storage region. The remaining sub-regions of the first storage region can be erased since their data exists in compressed form stored in the second storage region. If the log memory data are to be interrogated, the current data of the log memory are output. If the statistics data are to be interrogated, the log memory data are compressed and output together with the compressed, stored data. The stored, compressed data remain unchanged and are not overwritten.

The arrangement for implementation of the method includes a non-volatile memory, a microprocessor and a program memory that are operationally connected with one another. The non-volatile memory has a first storage region for data and a second storage region for compressed data. The program memory contains an application program that programs the microprocessor to
(I) store data associated with a type of event in a first storage region upon successive occurrences of the event until exceeding a threshold at the transition between sub regions of the first storage region,
(II) copy and compress first data from at least one sub-region into the lower address range upon exceeding the threshold, until the data compression is concluded,
(III) store the compressed first data in a second storage region, (IV) erase the first data from at least the sub-regions in the lower address range of the first storage region, and
(V) shift second data from the sub-regions in the upper address range of the first storage region to a sub-region in the lower address range of the first storage region, the shifted second data representing last-stored events.

The microprocessor can be programmed to react to a number of thresholds. A second threshold is a second threshold address (a predetermined address). A switch-on causes a compression of the data by the microprocessor when the second threshold is exceeded and does not initiate compression when the second threshold is not exceeded. A third threshold is a third threshold address or (predetermined address). During operation a compression of the data is made by the microprocessor when the third threshold is exceeded and does not initiate compression when the third threshold is not exceeded. It is furthermore provided that the address of each threshold is selected device-dependent or dependent on a machine state of a device.

Before each compression of data, a buffer can be initialized in order to buffer read-out data of the first storage region until a lower limit (for example the start address) in the uncompressed storage is reached, so as to then read data from the buffer and to establish an event type. For each event type the associated data are compressed and stored in the second storage region, and subsequently each event type that was stored in the second storage region is erased in the buffer. Alternatively, erasure of the remaining sub-regions in the first storage region can ensue with the shifting of the second data.

### DESCRIPTION OF THE DRAWINGS

FIG. 1 is a block diagram illustrating the basic components of a known franking system.

FIG. 2 illustrates a franking imprint according to DPAG (Deutsche Post) requirements,

FIG. 3 is a block diagram for an arrangement for storage and administration of data for a franking system in accordance with the invention.

FIG. 4 is a flowchart for the method for storage and administration of data in accordance with the invention.

FIG. 5 illustrates the clearing of storage regions in accordance with the invention.

FIG. 6 is a flowchart for the method for compression of data in accordance with the invention.

### DESCRIPTION OF THE PREFERRED EMBODIMENTS

FIG. 1 is a block diagram of the basic components of a known franking system 1, including a franking machine 2 to which is connected a deposit box 4 in the downstream mail direction and an automatic feed station 7 in the upstream mail direction. In a franking system of the type Ultimail®, a stack 6 of pending mail pieces is supplied. A stack of franked mail pieces can be removed from the deposit box 4. The automatic feed station 7 and a personal computer 9 are electrically connected via cables 71 and 91 at first and second interfaces 27 of the franking machine 2. The franking machine 2 can also be operated as a stand alone unit. It can be connected via modem 26 and a communication network 12 with a remote tele-postage data center 8 for the purpose of credit downloading and with a remote service center 11. The franking machine 2 has an internal static scale, or a scale interface 28 for an external scale, and a mainboard (motherboard) 20 equipped with a postage fee calculator. A current postage fee table can be transmitted from the remote service center 11 to the franking machine 2 or to the franking system 1. The franking machine 2 can optionally have a postal security device (PSD 29) (shown dashed).

A further known franking system by the applicant of the type Jetmail® in principle corresponds to the block image shown in FIG. 1, with the difference that a stack 6 of mail pieces standing on edge is supplied to the automatic feed station 7 and a dynamic scale (not shown) can be retrofitted. The dynamic scale can be arranged between the automatic feed station 7 and the franking machine 2.

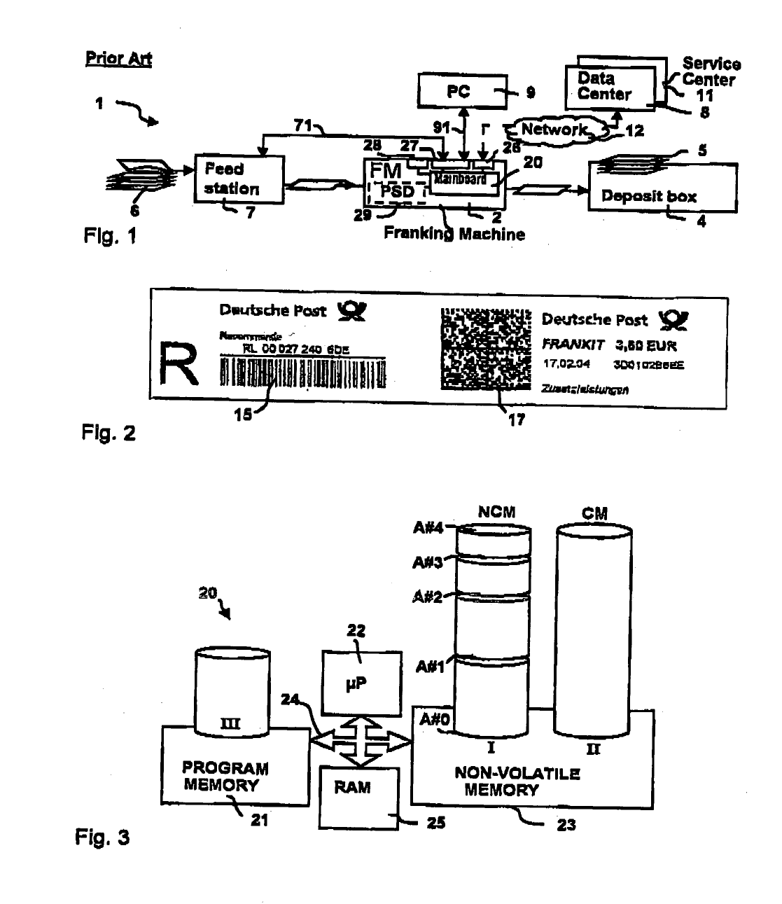

FIG. 2 shows a franking imprint according to the Frankit requirements of the Deutsche Post AG. The franking imprint has a one-dimensional bar code (1D barcode) 15 on the left for an identification code. In the value imprint the franking imprint has a two-dimensional barcode (2D barcode) 17 for verification of the proper payment of the mail piece transport fee. The 2D barcode is based on security-relevant data that are generated in the PSD. The non-volatile memory on the mainboard 20 of the franking machine 2 is used as a storage location for the identification code, but a non-volatile memory in the PSD of the franking machine 2 is used as a storage location for security-relevant data.

FIG. 3 shows a block diagram for an arrangement for storage and administration of data. A program memory 21, a microprocessor 22, a non-volatile memory 23 and a working memory RAM 25 are operationally connected with one another via a bus 24. The non-volatile memory 23 contains a first storage region I for data and a second storage region II for compressed data. The program memory 21 contains a third storage region III for an application program that programs the microprocessor 22 so that, upon the occurrence of an event to be statistically tracked, corresponding data are stored un the first storage region I until exceeding a threshold at the transition between the sub-regions thereof. The threshold is, for example, a predetermined address that is selected device-dependently or dependent on the machine state of a device. Upon exceeding the threshold, data are copied from at least the lower address range and are compressed until the data compression is concluded. The compressed data are stored in a second storage region II.

Alternatively, the storage regions I, II (i.e. for the non-compressed memory (NCM) and compressed memory (CM)) are two separate non-volatile memories.

The second storage region II or CM contains compressed data. the microprocessor 22 is programmed to erase the appertaining data at least from the sub-regions in the lower address range of the first storage region I after the compression, and then to shift the data from the sub-regions in the upper address range of the first storage region I to a sub-region in the lower address range of the first storage region I. Such data of the franking system 1 or the franking machine 2 are, for example, the last-stored error data and/or event data. Upon occurrence of a further (tracked) event, data (for example for an error statistic or other statistic) are written into the first non-volatile storage region I or NCM. In principle the following states occur in running operation:
The first storage region is still not completely filled with data and tracked events occur. The first data regarding the tracked events are stored in a first storage region that still has sufficient capacity for further entries—of second data—.
Event data are, for example, data that can concern the lifespan of the machine, errors or status information regarding security-relevant data. The non-volatile memory 23 on the mainboard 20 of the franking machine 2 is used as a log memory for such data. If the data are to be interrogated, the data present in the log memory are output.
A tracked event occurs that, after the storage, results in the first storage region I being filled with data to a predetermined point. Its first data can be compressed.

Upon compression of data, the uncompressed first data are read out from the first storage region I of the non-volatile memory 23 and are compressed. The now compressed data and the already compressed data stored in the second storage region II are merged and stored as compressed data in the second non-volatile storage region II.
The output of the statistics data is, among other things, ordered given a specific fill level. For this purpose, the data stored in the first storage region I are compressed and output together with the remaining compressed data from the second storage region II.

According to the preferred embodiment, the first storage region I is partitioned into four sub-regions and has thresholds that allow it to establish the respective occupancy states of these sub-regions.

A first sub-region lies between a start address A#0 and a predetermined first address A#1. Still-uncompressed information that concern the last stored events also always remain in the first sub-region after the compression of data. A second sub-region lies between the predetermined first address A#1 and a predetermined second address A#2. If the overflow of the second sub-region in the direction of a third sub-region is detected immediately after the activation, a compression of the data ensues, whereby only uncompressed data regarding last events is still present in the first sub-region as a result. A third sub-region lies between the predetermined second address A#2 and a predetermined third address A#3. After activating and powering up the device, this third sub-region can be occupied during the running operation without further activities being activated.

A fourth sub-region lies between the predetermined third address A#3 and a predetermined fourth address A#4. Specification of this region is established by overflowing the predetermined third address and leads to compression of the data from the lower log data ranges. Testing of each of the predetermined addresses ensues upon powering up the device, for example the franking machine 2. If, upon powering up the franking machine 2, it is established that the recording in log data regions has already reached into the third sub-regions, the data stored in the lower sub-regions of the first storage region I of the non-volatile memory 23 are likewise compressed. The volatile memory RAM 25 is thereby used as a buffer.

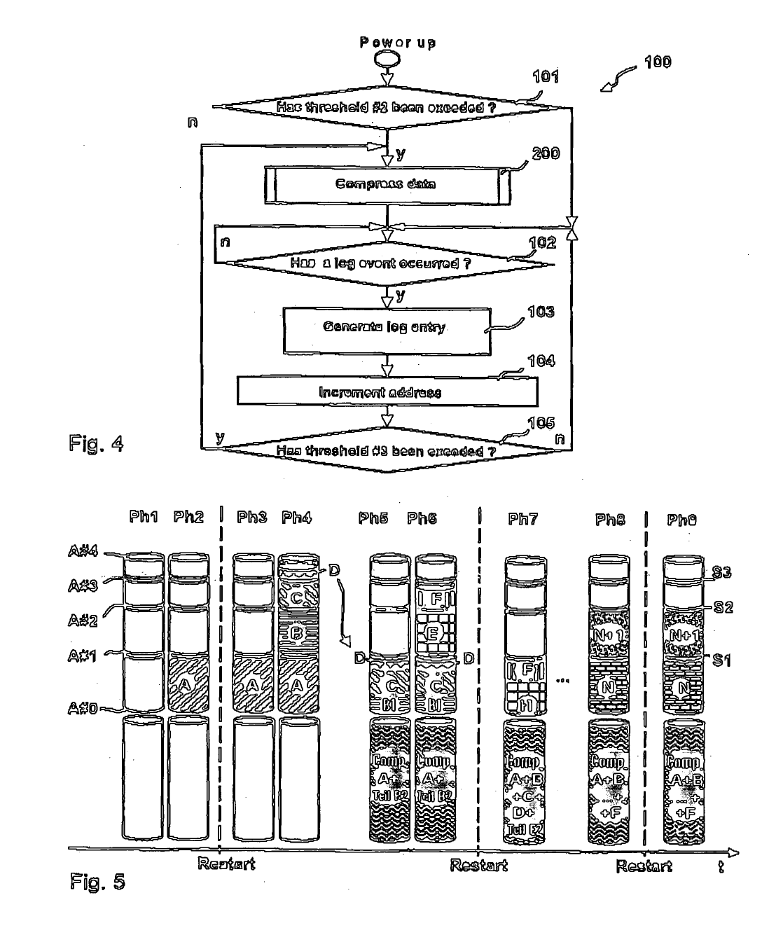

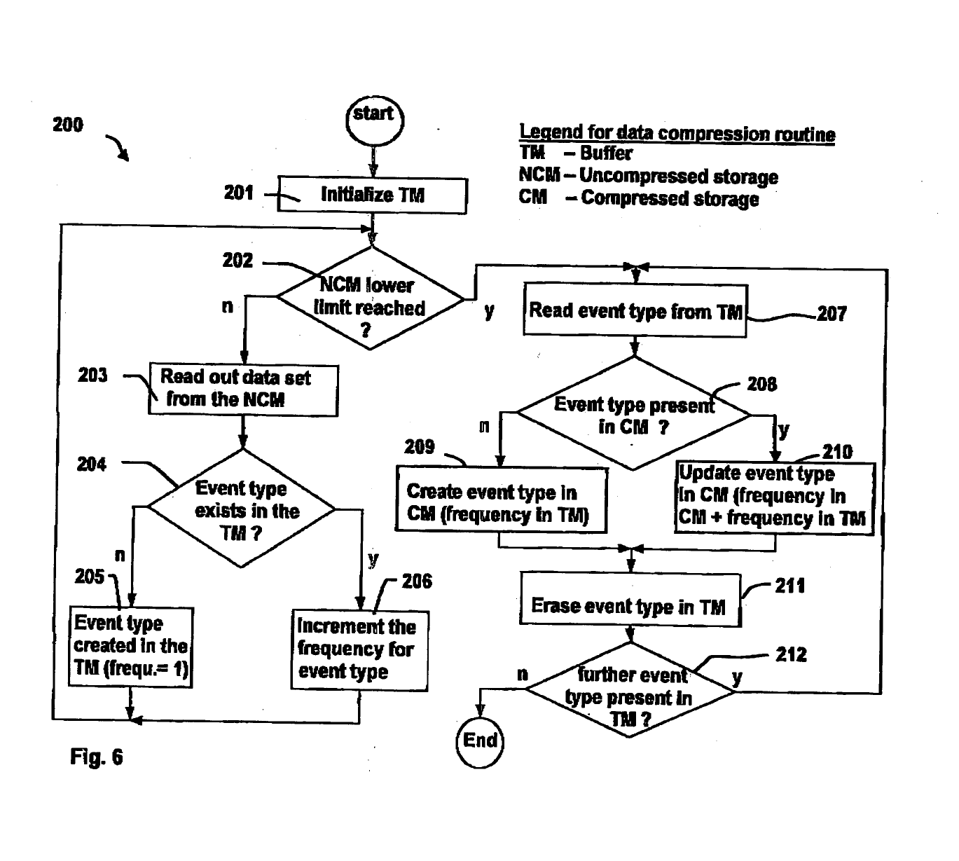

FIG. 4 shows a flowchart for the method for storage and administration of data. The method is realized as a sub-routine 100 after the activation. The franking machine 2 has a first query step 101 to establish an overflow of the second threshold address (predetermined address) A#2 which designates a second threshold #2. An overflow of the second threshold #2 means a complete filling of both of the first sub-regions with data. Given an unfilled state of the first two storage regions, the method branches from the first query step to a second query step 102 to determine whether there is a new event to be stored. Given a new event to be stored, a step 103 is reached and a log entry is generated, whereby a storage of data ensues in the first storage region I. If no event to be stored exists, the method branches into a wait loop in which it branches back to the beginning of the second query step 102. After the storage of data in the first storage region I, a step 104 for incrementing the address for the next log entry is reached. A third query step 105 is subsequently reached for establishment of an overflow of a third threshold address (predetermined address) A#3 which designates a third threshold #3. If no overflow of the threshold address A#3 exists, the method branches back to the second query step 102. Otherwise a processing step 200 is reached in order to copy data at least from the lower address range of the first storage region I and then to compress the data, and to implement a subsequent storage of the compressed data in the second storage region II, which is shown more precisely in FIG. 6. After ending the compression in the processing step 200, the second query step 102 is reached again in order to wait for a further log event. If, after a deactivation and re-activation of the franking machine, it is established that the second threshold #2 has been exceeded, the method then branches to the compression of the data in the processing step 200.

Further thresholds or queries can be necessary in a franking machine or mail processing system. The sub-routine 100 can be expanded by further queries for overrun of further thresholds, whereby the queries ensue at different points in time and initiate corresponding different reactions, which was explained in principle using the mode of operation of FIG. 4. The reactions ensue in a manner adapted to the respective system and the desired object.

FIG. 5 shows a representation of the clearing (purging) of storage regions of a log memory dependent on events and on a time curve. The first of two storage regions I and II is shown in an upper row and has four sub-regions. The second of the two storage regions is shown in a lower row and is provided only for compressed data. For example, phases Ph1 through Ph9 occur in succession in the time t.
Ph1: Delivery of the unused machine to the customer/user/
Ph2: use of the machine by the customer or, respectively, user and storage of uncompressed first usage data A in the first storage region I. The first usage data A lie in the first sub-region between a start address A#0 and a first threshold address A#1.
Ph3: After a restart of the machine by the customer or, respectively, user, the uncompressed first usage data A are furthermore present in the first storage region I of the machine.
Ph4: After a use of the machine by the customer or, respectively, user, a storage of uncompressed further usage data B, C and D ensues in addition to the first usage data A, at least in the second sub-region of the first storage region I. The second sub-region lies between the first threshold address A#1 and a second threshold address A#2. A third sub-region lies between the second threshold address A#2 and a third threshold address A#3. A fourth sub-region lies between the third threshold address A#3 and a fourth threshold address A#4.
Ph5: The overflow of the third sub-region in the direction of the fourth sub-region is now detected. A compression of the data follows, such that only the uncompressed usage data D and C as well as a part B1 of the originally-stored usage data B remain further in the first sub-region of the first storage region I of the machine while the first usage data A and a part B2 of the originally-stored usage data B are read out from the first storage region I of the machine and are stored compressed in a second storage region II of the machine.
Ph6: After a use of the machine by the user and storage of uncompressed further usage data E and F in addition to the remaining usage data D, C and part B1 in the first storage region I, the machine is deactivated.
Ph7: After a restart of the machine by the user, upon powering up the machine it is established that the recording in the log data regions has already reached into the third sub-region. As a result of the compression, the uncompressed further usage data F and part E1 of the originally-stored usage data E remain in the first sub-region of the first storage region I of the machine. Upon compression, the further usage data part E1, D, C and B1 are read out from the first storage region I of the machine and stored compressed in the second storage region II of the machine, together with the usage data A and B2.\
Ph8: After a use of the machine by the user and data administration in the aforementioned manner, causing a storage of compressed usage data A+B+ . . . +F to ensue together in the second storage region II and of uncompressed n-th usage data N in the first storage region I, additional uncompressed further usage data N+1 are stored in the second sub-region of the first storage region I. The machine is then deactivated.
Ph9: After a restart of the machine by the customer or, respectively, user, the uncompressed further usage data N+1 and the preceding n-th usage data N still remain in the first storage region I of the machine, since the second threshold S2 has not yet been exceeded. The remaining preceding usage data A+B+ . . . +F remain stored compressed in the second storage region II of the machine.

FIG. 6 shows a flowchart for the method for compression of data that, for example, are necessary in the framework of a special service. The method is, for example, realized as a sub-routine 200 of a franking machine and, after the start, has a first initialization step 201 in order to initialize a buffer RAM 25 and a first query step 202 to establish a condition for ending the compression of the data in the sub-regions. A suitable condition is reaching a predetermined address of the first storage region I. A predetermined address is, for example, the start address at the beginning of the first storage region I when first data have been processed from a higher address to the lowest address as a lower limit of the first storage region I, and whereby second data exist from the higher address upwards. Another predetermined address is, for example, a higher address at the boundary (transition) between first and second data of the first storage region I when first data have been processed from the lowest address to the higher address of the first storage region I, and whereby second data exist from the higher address upwards. If, in the query, it is established that the start address at the beginning of the first storage region I has not yet been achieved, the method then branches to step 203 in order to read a data set from an uncompressed sub-region. The method then branches to a second query step 204 to query for a presence of an event type in the buffer 25.

If no corresponding event type exists in the buffer 25, in step 205 an entry corresponding to the event type is created in the buffer 25. However, if an entry of the corresponding event type was already created in the buffer 25, then the method branches from the second query step 204 to the step 206 in order to increment a counter state of a first counter corresponding to the frequency of occurrence of the event of the same type. From step 205 or from step 206, the method branches back to the first query step 202 to establish a condition for ending the compression of the data in the sub-regions. Upon reaching the predetermined address (start address or address as the transition between the first and second data of the first storage region I), the data content exists stored in the buffer TM, for example in a RAM 25. A step 207 for reading an entry of an event type out from the buffer 25 is now reached, and subsequently a third query step 208.

In the third query step 208 it is checked whether the appertaining event type is already present in the second storage region II with the compressed data. If this is still not the case, a step 209 is then reached in order to create an entry of the appertaining event type in the second storage region II. Otherwise, when in the third query step 208 it is established that the appertaining event type is already present in the second storage region II with the compressed data, a step 210 is then reached in order to increment a counter state of a second counter corresponding to the frequency of events for the appertaining event type in the second storage region II. From the step 209 or from the step 210, the method branches to an erasure step 211 to erase the event type buffered in RAM 25 before a fourth query step 212 is reached. In the fourth query step 212, it is checked whether a further event type exists buffered in the RAM 25. If this is the case, the method branches back to the step 207 in order to read a further event type out from the RAM 25. Otherwise the end of the routine 200 is reached after the fourth query step 212 (step 213).

The aforementioned algorithm for the data compression of the event storage has the result that all previously acquired data are no longer found in the storage region II or in (the storage for compressed data). Instead, only (for example) the event identification and the count of the occurrence of the event are located there. The events are listed in ascending or descending order of the frequency values in the statistic, together with their event numbers. Upon compression of the data, the data reduced in terms of their information are transferred into a new list together with the existing data reduced in terms of their information, which list has the known structure (order of the frequencies and their event numbers). This list is then stored in the storage region for compressed data. Other reductions are likewise conceivable.

Exemplary embodiments for data retention of the compressed storage region (statistic) are:
1. A counter for the event frequency is created pre-initialized with the value zero for each possible event upon creation of the compressed storage region. The event number can thereby likewise be recorded.
2. The events are transferred in the order of their occurrence into the uncompressed storage, in the statistic, via transfer of the event number and the frequency=1.
3. The events are listed in the statistic with their event number in ascending/descending order of frequency.

For all exemplary embodiments only the frequency of occurrence information is incremented given events already listed in the statistics.

The term “franking system” as used herein also encompasses a PC franker formed by a personal computer with a PSD and a conventional office printer. The method described above can also be implemented in a personal computer.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for storage and administration of data, using a log memory divided into a first storage region and a second storage region, said first storage region comprising a plurality of sub-regions and having an upper address range containing at least one of said sub-regions and a lower address range containing at least one other of said sub-regions, comprising the steps of:
storing data associated with a type of event, upon each successive occurrence of the event, in the first storage region until overflowing a threshold at a transition between sub-regions of the first storage region;
copy and compressing first data from at least one sub-region in the lower address range of the first storage region until concluding data compression;
storing the compressed first data in the second storage region;
deleting said first data from said at least one sub-region in the lower address range of the first storage region; and
shifting second data from at least one sub-region in the upper address range of the first storage region to a sub-region in the lower address range of the first storage region, said shifted data representing last-stored events.

2. A method as claimed in claim 1 comprising compressing said data using a data compression algorithm wherein at least a portion of the uncompressed data of said log memory is read and compressed.

3. A method as claimed in claim 2 comprising, upon compression of said data, combining newly compressed first data and previously compressed and stored data to form combined data, and storing said combined data as compressed data in said second storage region.

4. A method as claimed in claim 2 comprising, upon compression of said data, compressing data for each of a plurality of different types of event, and incrementing a counter representing a frequency of occurrence of each type of event.

5. A method as claimed in claim 1 comprising setting said threshold as a threshold address in said first storage region dependent on said type of event.

6. A method as claimed in claim 1 wherein said events occur in a device exhibiting a plurality of machine states, and comprising setting said threshold as a threshold address dependent on a machine state of said device.

7. A method as claimed in claim 1 comprising, before each data compression, initializing a buffer to buffer read-out data from said first storage region until a predetermined address in the uncompressed storage is reached, and subsequently reading data from the buffer to establish said type of event, with data being compressed and stored in the second storage region for each type of event, and subsequently deleting the type of event in the buffer that has been stored in the second storage region.

8. An apparatus for storage and administration of data associated with events occurring during operation of the apparatus, said apparatus comprising:
a microprocessor;
a non-volatile memory in communication with said microprocessor, said non-volatile memory containing a first storage region for data and a second storage region exclusively for compressed data, said first storage region comprising a plurality of sub-regions including at least one sub-region in an upper address range of the first storage region and at least one other sub-region in a lower address range of the first storage region; and
a program memory in communication with said microprocessor and having a program stored therein on a storage medium, said program programming said microprocessor to:
store data associated with a type of event, upon each successive occurrence of the event, in said first storage region until exceeding a threshold at a transition between two of said sub-storage regions;
upon said threshold being exceeded, to copy first data from at least one sub-region in said lower address region of said first storage region and to compress the copied data until data compression is completed;
to store the compressed first data in the second storage region;
to erase the first data from said at least one sub-region in the lower address range of the first storage region; and
to shift second data from at least one sub-region in the upper address range of the first storage region to a sub-region in the lower address range of the first storage region, the shifted second data representing last-stored events.

9. An apparatus as claimed in claim 8 further comprising a working memory in communication with said microprocessor and wherein said program stored in said program memory additionally programs said microprocessor to initialize said working memory as a buffer to buffer data read from said first storage region during data compression.

10. An apparatus as claimed in claim 8 wherein said program stored in said program memory additionally programs said microprocessor to react to a plurality of thresholds, with said threshold at said transition being a first of said plurality of thresholds, and including a second threshold that, upon being exceeded, causes a switch-on to initiate compression of said first data by said microprocessor and does not initiate compression if not exceeded.

11. An apparatus as claimed in claim 10 wherein said program stored in said program memory programs said microprocessor to react to a third threshold which, when during operation exceeded, initiates compression of said first data by said microprocessor and does not initiate compression when not exceeded.

12. An apparatus as claimed in claim 8 wherein said non-volatile memory comprises a first memory unit comprising said first storage region and a second memory unit, separate from said first memory unit, comprising said second storage region.
